(19) United States
(12) Patent Application Publication
(10) Pub. No.: US 2010/0088016 A1
(43) Pub. Date: Apr. 8, 2010

(54) ENVIRONMENTALLY AWARE TRAVEL ROUTING

(75) Inventors: Amit R. Aghara, Boca Raton, FL (US); Thomas E. Creamer, Boca Raton, FL (US); Baiju D. Mandalia, Boca Raton, FL (US); Jonathan Palgon, Boynton Beach, FL (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/244,605

(22) Filed: Oct. 2, 2008

(51) Int. Cl. G05B 19/04

(52) U.S. Cl. 701/201

(57) ABSTRACT

Embodiments of the present invention address deficiencies of the art in respect to automated travel planning and provide a novel and non-obvious method, system and computer program product for generating travel routes. A method for generating a travel route for a vehicle from a first location of the vehicle to a second location can be provided. The method can include comprising calculating a travel route from the first location to the second location, wherein the travel route is based on an environmental effect of the vehicle during the travel route. In one alternative, calculating the environmental effect of the vehicle during the travel route can be executed by calculating emissions of the vehicle during the travel route. In another alternative, the travel route comprises calculating a series of travel segments along said travel route, and the environmental effect of the vehicle during the travel route is calculated by determining a type of environment for each of the travel segments of the travel route.

### REFERENCE TO CO-PENDING APPLICATIONS FOR PATENT

The present application is related to the following co-assigned U.S. Patent Applications, which are expressly incorporated by reference herein:

U.S. application Ser. No. ______, entitled “OPTIMIZATION OF TRAVEL ROUTING” (docket no RSW920080307US1 (417U)), filed on Oct. 2, 2008.

### BACKGROUND OF THE INVENTION

1. Field of the Invention

The present invention relates to automated travel planning systems, and more particularly relates to automated travel planning systems that take environmental factors into account.

2. Description of the Related Art

Computerized travel routing systems assist motorists in determining preferred routes in traveling between two or more locations. Users typically specify a starting point and an ending destination and the travel routing system determines the route with the shortest distance between the two locations. Alternatively, the travel routing system may determine the route with the shortest travel time between the two locations. Various web sites are currently available that provide this functionality to online users. In addition, certain car manufacturers have incorporated similar computerized mapping systems into their automobiles' on-board computer systems.

In general, computerized travel routing systems function as follows. After a user enters starting and ending destinations, the travel routing system accesses a map database containing road information. Each road in the database may be broken up into segments. The segments may begin and end at intersections, speed zones, or a change in the number of lanes. The information of a road segment in the map database may include: the length of the segment, speed limit, and which road segments connect to the endpoints of the segment. The travel routing system may plot out a number of probable routes comprised of road segments connecting the starting point and the destination. An estimated travel time for each route may be calculated by summing the quotient of the distance traveled in a particular speed zone by the speed limit of the zone. A travel route may then be selected based on the shortest travel distance, shortest estimated time required to travel the route or some combination of the two. The selected travel route may then be displayed to the user.

Although conventional computerized travel routing systems, as described above, provide travel routes that may be optimized for distance, time or some combination of the two, there are other factors that the user may find desirable to take into account. Conventional computerized travel routing systems, however, are limited in the manner in which they determine routes and the number of factors that are considered when determining optimized routes.

Therefore, a need arises for a more a method for providing computerized travel routing that takes additional considerations into account.

### BRIEF SUMMARY OF THE INVENTION

Embodiments of the present invention address deficiencies of the art in respect to automated travel planning and provide a novel and non-obvious method, system and computer program product for generating travel routes. In one embodiment of the invention, a method for generating a travel route for a vehicle from a first location of the vehicle to a second location can be provided. The method can include comprising calculating a travel route from the first location to the second location, wherein the travel route is based on an environmental effect of the vehicle during the travel route. In another embodiment of the invention, calculating the environmental effect of the vehicle during the travel route can be executed by calculating emissions of the vehicle during the travel route. In another embodiment of the invention, the travel route comprises calculating a series of travel segments along said travel route, and the environmental effect of the vehicle during the travel route is calculated by determining a type of environment for each of the travel segments of the travel route. In another embodiment of the invention, the environmental effect of the vehicle during the travel route is calculated by determining environmental airflow for each of the travel segments of the travel route.

In yet another embodiment of the invention, a computer system comprising a server for generating a travel route for a vehicle from a first location of the vehicle to a second location can be provided. The system can include an interface for receiving the first location of the vehicle and the second location and a repository for storing travel segments for a geographical area. The system can further include a processor con figured for calculating a travel route from the first location to the second location, wherein the travel route comprises a series of travel segments and wherein the travel route is based on an environmental effect of the vehicle on each of the travel segments.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a process for generating a travel route based on environmental factors, according to one embodiment of the present invention;

FIG. 2 is a flow chart depicting a general process for generating a travel route based on environmental factors, according to one embodiment of the present invention;

FIG. 3 is an illustration of generated travel route optimized for distance;

FIG. 4 is an illustration of generated travel route optimized for time; and

FIG. 5 is an illustration of generated travel route optimized for environmental effect, according to one embodiment of the present invention.

### DETAILED DESCRIPTION OF THE INVENTION

Embodiments of the present invention address deficiencies of the art in respect to automated travel planning and provide a novel and non-obvious method, system and computer program product for generating travel routes. The present invention generates a travel route for a vehicle from a first location of the vehicle to a second location, wherein the travel route is based on an environmental effect of the vehicle during the travel route. The environmental effect of the vehicle during the travel route can be determined by calculating emissions of the vehicle during the travel route. Also, the travel route may comprise a series of travel segments along said travel route. In this case, the environmental effect of the vehicle during the travel route can be calculated by determining a type of environment for each of the travel segments of the travel route. Alternatively, the environmental effect of the vehicle during the travel route can be calculated by determining environmental airflow for each of the travel segments of the travel route.

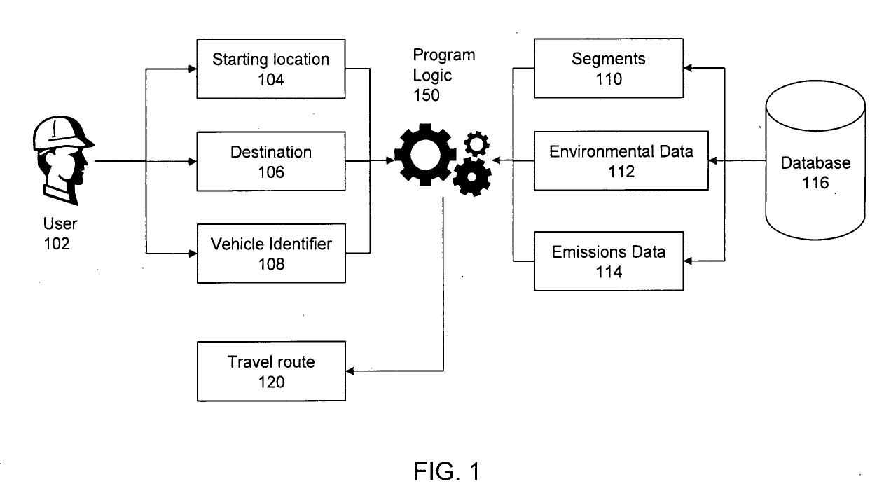

FIG. 1 is a block diagram illustrating a process for generating a travel route based on environmental factors, according to one embodiment of the present invention. FIG. 1 shows that a user 102 may interact with program logic 150 to provide a starting location 104 for a desired travel route, a destination 106 for the travel route and an identifier 108 for the vehicle of the user 102. The program logic 150 includes program code for generating a travel route based at least on the information 104, 106, 108 provided by the user 102. Before program logic 150 generates a travel route, segments 110 are retrieved from a map database, such as database 116.

Further, environmental data 112 for the segments are retrieved by program logic 150 from an environmental database, such as database 116. Environmental data may comprise air flow rates for a segment, wherein airflow for a geographical area is related to the environmental effect of emissions deposited in that area. Areas with low airflow rates are affected to a higher extent by emissions since the emissions are less likely to dissipate. Areas with higher airflow rates are affected to a lower extent by emissions since the emissions are more likely to dissipate.

Environmental data may comprise an environmental type indicator for a segment, wherein a type of environment for a geographical area is related to the environmental effect of emissions deposited in that area. Urban areas with little greenery are affected to a higher extent by emissions since temperatures are higher, emissions are less likely to dissipate and less oxygen is being produced by plants and trees. Rural areas, including forests and grasslands, are affected to a lesser extent by emissions since temperatures are lower, emissions are more likely to dissipate and more oxygen is being produced by plants and trees.

Also, emissions data 114 is retrieved by program logic 150 from an emissions database, such as database 116. Emissions data may include the amount, quality and constituency of emissions of a particular vehicle (as identified by user 102 in vehicle identifier 108) at various speeds of operation. After having gathered the information 104, 106, 108 entered by user 102 and the information 110, 112, 114 retrieved from database 116, the program logic 150 calculates a travel route 120 optimized to minimize the effect of the vehicle of user 102 upon the environment. The travel route 120 may further be optimized for distance of the route (so as to minimize distance), travel time of the route (so as to minimize travel time) or both.

Program logic 150 can be coupled to a computer usable by user 102 and/or a server further coupled to a network. The computer or server housing the program logic 150 includes computer hardware and software designed to receive (such as via a graphical user interface) a starting location 104, a destination 106 and a vehicle identifier 108, retrieve segments 110, environmental data 112 and emissions data 114 from a database 116, determine an optimal travel route 120, and communicate the optimal route to the user 102. In this embodiment, the user 102 uses a keyboard or other input device to enter the information identified above. The input device may also include a touch-screen display or voice input to a voice processing system. A display device may also be arranged to receive and selectively display mapping information developed by the program logic 150.

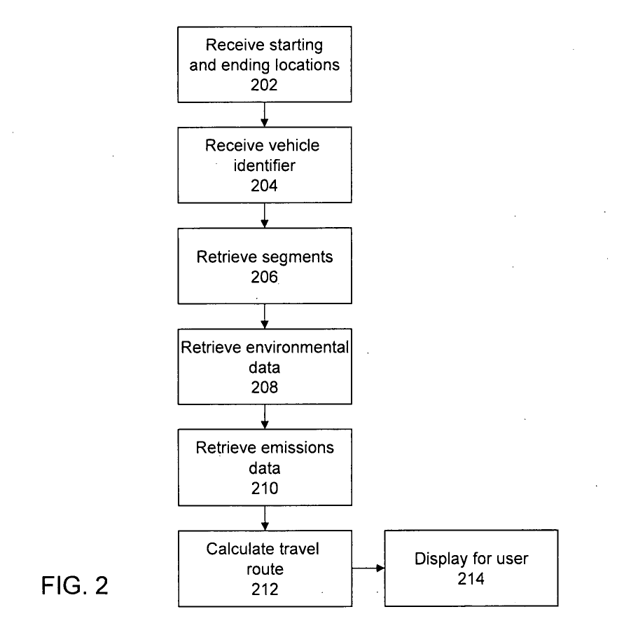

FIG. 2 is a flow chart depicting a general process for generating a travel route 120 based on environmental factors, according to one embodiment of the present invention. In block 202, the user 102 may interact with program logic 150 to provide a starting location 104 for a desired travel route and a destination 106 for the desired travel route. In block 204, the user 102 may interact with program logic 150 to provide an identifier 108 for the vehicle of the user 102. In block 206, program logic 150 retrieves segments 110 from a map database, such as database 116. In block 208, environmental data 112 for the segments are retrieved by program logic 150 from an environmental database, such as database 116. In block 210, emissions data 114 is retrieved by program logic 150 from an emissions database, such as database 116.

In block 212, after having gathered the information 104, 106, 108 entered by user 102 and the information 110, 112, 114 retrieved from database 116, the program logic 150 calculates a travel route 120 optimized to minimize the effect of the vehicle of user 102 upon the environment. The travel route 120 may further be optimized for distance of the route, travel time of the route or both. In block 214, a display device may be arranged to display mapping information developed by the program logic 150 for the user 102.

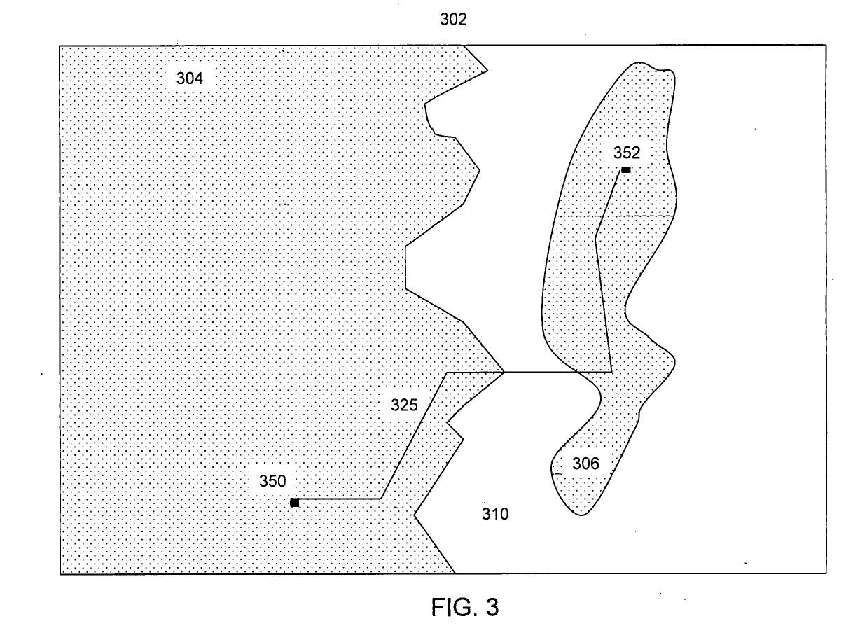

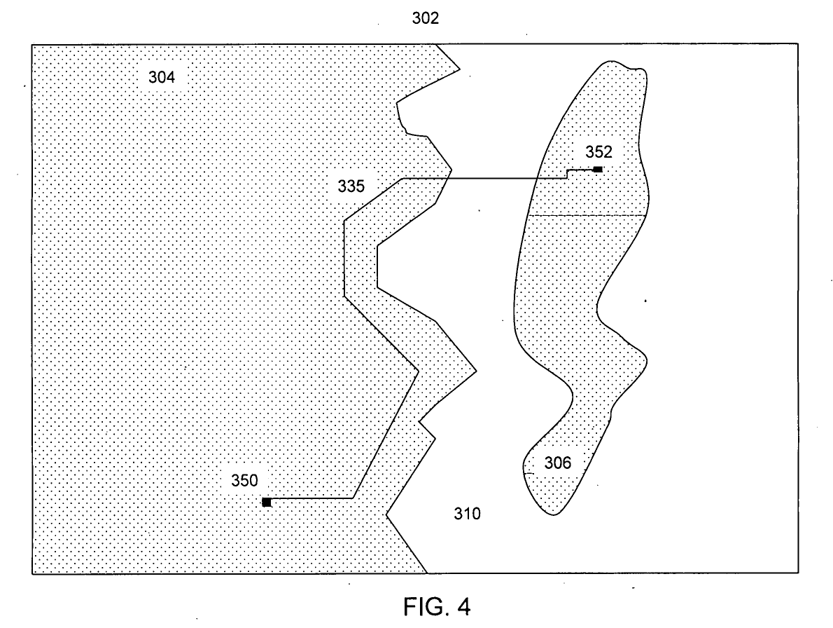

FIG. 3 is an illustration of generated travel route 325 optimized for distance. FIG. 3 shows a display 302 showing a map including a mainland 304, a body of water 310 and an island 306. A user desires to travel from starting point 350 to destination 352. A travel route 325 has been generated that optimizes the distance from point 350 to point 352. FIG. 4 is an illustration of generated travel route 335 optimized for time. FIG. 4 shows the same display 302 as FIG. 3. A travel route 335 has been generated that optimizes the travel time from point 350 to point 352.

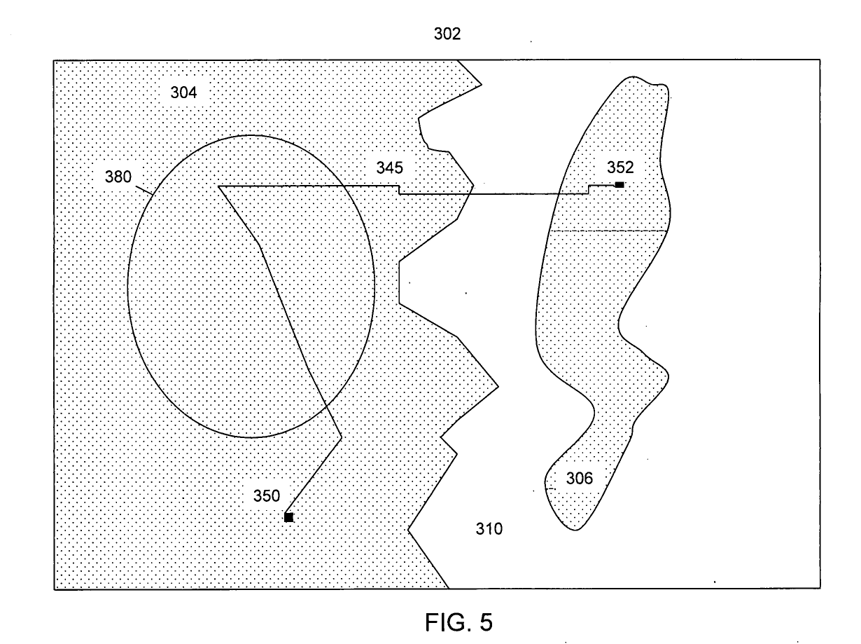

FIG. 5 is an illustration of generated travel route 345 optimized for environmental effect, according to one embodiment of the present invention. FIG. 5 shows the same display 302 as FIG. 3. A travel route 345 has been generated that optimizes (i.e., minimizes) the environmental effect of a particular vehicle traveling from point 350 to point 352. It is shown in FIG. 5 that the route 345 has been directed through area 380, which is an area with a high airflow rate. Areas with higher airflow rates are affected to a lower extent by emissions since the emissions are more likely to dissipate. Further, area 380 is a forest area. Rural areas, including forests and grasslands, are affected to a lesser extent by emissions since temperatures are lower, emissions are more likely to dissipate and more oxygen is being produced by plants and trees. Thus, although the route 345 may have a greater travel time than routes 325, 335 and the route 345 may have a longer distance than routes 325, 335, route 345 has a smaller environmental impact than routes 325, 335.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for generating a travel route for a vehicle from a first location of the vehicle to a second location, comprising calculating a travel route from the first location to the second location, wherein the travel route is based on an environmental effect of the vehicle during the travel route.

2. The method of claim 1, further comprising calculating the environmental effect of the vehicle during the travel route by calculating emissions of the vehicle during the travel route.

3. The method of claim 1, further comprising receiving emissions data for the vehicle and calculating the environmental effect of the vehicle during the travel route by calculating emissions of the vehicle during the travel route based on the emissions data.

4. The method of claim 1, wherein calculating the travel route comprises calculating a series of travel segments along said travel route, and further comprising calculating the environmental effect of the vehicle during the travel route by determining a type of environment for each of the travel segments of the travel route.

5. The method of claim 1, wherein calculating the travel route comprises calculating a series of travel segments along said travel route, and further comprising calculating the environmental effect of the vehicle during the travel route by determining environmental airflow for each of the travel segments of the travel route.

6. A computer system comprising a server for generating a travel route for a vehicle from a first location of the vehicle to a second location, comprising:
an interface for receiving the first location of the vehicle and the second location;
a repository for storing travel segments for a geographical area; and
a processor configured for:
calculating a travel route from the first location to the second location, wherein the travel route comprises a series of travel segments and wherein the travel route is based on an environmental effect of the vehicle on each of the travel segments.

7. The computer system of claim 6, wherein the processor is further configured for calculating the environmental effect of the vehicle on each of the travel segments by calculating emissions of the vehicle on each of the travel segments.

8. The computer system of claim 6, wherein the repository further includes emissions data for the vehicle and wherein the processor is further configured for calculating the environmental effect of the vehicle on each of the travel segments by calculating emissions of the vehicle on each of the travel segments based on the emissions data.

9. The computer system of claim 6, wherein the processor is further configured for calculating the environmental effect of the vehicle on each of the travel segments by determining a type of environment for each of the travel segments.

10. The computer system of claim 6, wherein the processor is further configured for calculating the environmental effect of the vehicle on each of the travel segments by determining environmental airflow for each of the travel segments.

11. A computer program product comprising a computer usable medium embodying computer usable program code for generating a travel route for a vehicle from a first location of the vehicle to a second location, comprising:
computer usable program code for calculating a travel route from the first location to the second location, wherein the travel route is based on an environmental effect of the vehicle during the travel route.

12. The computer program product of claim 11, further comprising computer usable program code for calculating the environmental effect of the vehicle during the travel route by calculating emissions of the vehicle during the travel route.

13. The computer program product of claim 11, further comprising:
computer usable program code for receiving emissions data for the vehicle; and
computer usable program code for calculating the environmental effect of the vehicle during the travel route by calculating emissions of the vehicle during the travel route based on the emissions data.

14. The computer program product of claim 11, wherein the computer usable program code for calculating the travel route comprises computer usable program code for calculating a series of travel segments along said travel route, and wherein the computer program product further comprises:
computer usable program code for calculating the environmental effect of the vehicle during the travel route by determining a type of environment for each of the travel segments of the travel route.

15. The computer program product of claim 1, wherein the computer usable program code for calculating the travel route comprises computer usable program code for calculating a series of travel segments along said travel route, and wherein the computer program product further comprises:
computer usable program code for calculating the environmental effect of the vehicle during the travel route by determining environmental airflow for each of the travel segments of the travel route.

16. A method for generating a travel route for a vehicle, comprising:
receiving a first location of the vehicle and a second location of the vehicle;
calculating a travel route for the vehicle from the first location to the second location, wherein a travel route comprises a series of travel segments, and wherein the travel route is optimized so as to minimize an environmental effect of the vehicle upon each of the travel segments.

17. The method of claim 16, further comprising:
receiving emission data for the vehicle.

18. The method of claim 17, wherein calculating the travel route comprises:
calculating the travel route for the vehicle from the first location to the second location, wherein the travel route comprises a series of travel segments, and wherein the travel route is optimized so as to minimize an environmental effect of the vehicle upon each of the travel segments as indicated by the emissions data.
